(19) United States
(12) Patent Application Publication
(10) Pub. No.: US 2009/0323084 A1
(43) Pub. Date: Dec. 31, 2009

(54) Package dimensioner and reader

(76) Inventors: Joseph Christen Dunn, Lancaster, CA (US); Paul James Biberacher, Thousand Oaks, CA (US); Nicholas James Pauly, Boise, ID (US)

Correspondence Address: Cislo & Thomas LLP, 1333 2nd Street, Suite #500, Santa Monica, CA, 90401-4110, US

(21) Appl. No.: 12/215,062

(22) Filed: Jun. 25, 2008

(51) Int. Cl. G01B 5/02; G01B 11/02

(52) U.S. Cl. 356/635; 702/158

(57) ABSTRACT

A package dimensioner and reader having a reference surface to support an object; a measurement system comprising at least one laser above the reference surface generating at least one laser beam directed towards the reference surface, and a first optical detection device above the reference surface and adjacent to the at least one laser; and a processor operatively connected to the measurement system to process an image view captured by the optical detection device. The image view comprises an object image and a laser beam image. Based on the image view the processor calculates characteristics of the box such as the height. Other characteristics of the object may be determined such a length, width, and weight, sender or receiver information, and other related information regarding the transit of the object. The package dimensioner and reader may further comprise a second optical detection device to capture other information regarding the object.

### TECHNICAL FIELD

This invention relates to a method and apparatus for automatically determining the characteristics of a package, such as weight and dimensions, at the point of package acceptance.

### BACKGROUND

It may be desirable for the employee of the shipping organization to know certain physical characteristics of a package being dropped off by the customer. For example, the price which the organization charges the customer may be determined in whole or in part on the weight of the package. Alternatively, the price may be determined in light of the shape or dimensions of the package. In another example, the employee may be required to sort the package based on its physical characteristics. If the customer is unable to provide the dimensions, or if the employee is to verify the customers reported dimensions, some sort of characteristic determination must be employed. Waiting to perform such determinations until the package is transferred to a conveyor system equipped to do the job may result in significant delay if the customer is required to wait. Alternatively, if the customer is excused before such determinations are made, insufficient or excessive fees may be assessed. For these reasons, and others, it may be desirable to enable the employee to perform characteristic determination quickly and accurately at the point of package acceptance.

Determining the dimensions and weight of a package are essential to modern methods of shipping. For example, the price charged to ship an item may be determined in whole, or in part, on the shape, size, or weight of the item. In another example, shippers may choose to sort or organize packages based on the absolute or relative dimensions or weight of each package in order to optimize the way in which transport vehicles are loaded and routed. For these and many other reasons, numerous efforts have been made to facilitate quick and effective determination of object characteristics such as physical dimensions and weight. For example, numerous characteristic acquisition systems have been patented. The systems and methods known in the art for object characterization are commonly designed for large scale use as part of a conveyer system and involve elaborate arrays of sensors and other assorted hardware.

Capturing, storing and processing a picture of the customer and the package would be also useful information to track the package and the persons submitting the package.

For the foregoing reasons there is a need for a convenient, economic means for determining characteristics of an object at the point of package acceptance.

### SUMMARY OF THE INVENTION

The present invention is directed to systems and methods for determining the characteristics of an object or package and a customer. In one embodiment, a camera and a set of lasers are positioned at a distance from an object or package. The lasers are directed towards the object and the camera is directed to detect the location of the laser beam on the object. A processor is used to determine the relative positions of the laser beam projection within the field of detection of the camera and determine the distance of the object from the camera or other reference surface.

In another embodiment, a processor may use this distance measurement along with the profile of the object within the camera's field of detection to determine one or more additional physical characteristics of the object. In one example, these one or more additional physical characteristics may be the perimeter of the object, or, if the object is rectangular, the object's length and width.

In another embodiment, the reference surface may be a weight measuring device and the weight of the object may be determined before, during, or after the process of determining other physical characteristics of the object. In another embodiment, additional information may be collected to associate the object or package to the customer.

In another embodiment, the above features may be integrated with other standard features such as processors, scale, printers, scanners, etc. into a single mailing point of sale or self service device. The preceding is meant only to illustrate some of the embodiments of the present invention and is not to be read to limit the scope of the invention. A more detailed description may be found below.

### BRIEF DESCRIPTION OF DRAWINGS

FIG. 1 shows a perspective view of an embodiment of the present invention;

FIG. 2A shows a front view of an embodiment of the present invention with the support member removed for clarity, and an object;

FIG. 2B shows an image frame captured by the embodiment shown in FIG. 2A;

FIG. 3A shows a front view of the embodiment shown in FIG. 2A with a different sized object;

FIG. 3B shows an image frame captured by the embodiment shown in FIG. 3A;

FIG. 4A shows a front view of another embodiment of the present invention with the support member removed for clarity;

FIG. 4B shows an image frame captured by the embodiment shown in FIG. 4A;

FIG. 5A shows a front view of the embodiment shown in FIG. 4A but with an object in place;

FIG. 5B shows an image frame captured by the embodiment shown in FIG. 5A;

FIG. 6A shows a front view of the embodiment shown in FIG. 5A with the laser turned off;

FIG. 6B shows an image frame captured by the embodiment shown in FIG. 6A;

FIG. 7A shows a front view of the embodiment shown in FIG. 6A with an object in place;

FIG. 7B shows an image frame captured by the embodiment shown in FIG. 7A;

FIG. 8 shows a flow diagram of a method of determining a dimension of an uncharacterized object according to the present invention;

FIG. 9 shows a flow diagram of a method of determining other characteristics of an uncharacterized object according to the present invention; and

FIG. 10A shows another embodiment of the present invention with an uncharacterized object with a non-uniform top surface;

FIG. 10B shows an image frame captured by the embodiment shown in FIG. 10A;

FIG. 10C shows another image frame captured by a variation of the embodiment shown in FIG. 10A;

FIG. 10D shows another image frame captured by another variation of the embodiment shown in FIG. 10A; and

FIG. 11 shows another embodiment of the present invention.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

It will be further appreciated that while the package or object is depicted as a rectangular box, embodiments of the present invention are not limited to operation on similarly shaped packages. For clarity in explanation, however, when rectangular box type objects are described, the following standard reference system will be used unless otherwise stated. The dimension extending perpendicularly from a reference surface 102 upon which an object 10 rests will be referred to as the object's height H. The longer of the remaining two dimensions will be referred to as the object's length L. The remaining dimension will be referred to as the object's width W. Again, it will be appreciated that this reference is adopted solely for the purpose of explanation and not as a limitation on the scope or operation of embodiments of the present invention.

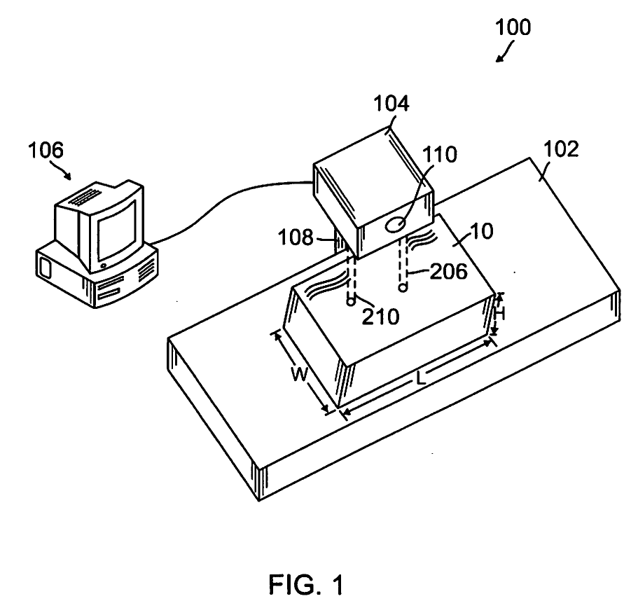

As shown in FIG. 1, the package dimensioner and reader 100 comprises a reference surface 102, a measurement system 104, and a processing device 106. The reference surface 102 provides a stable surface onto which an object or package 10 may be placed for processing. The reference surface 102 may also provides a means for calibrating the measurement system 104. In some embodiments, objects of known characteristics, for example, objects with known length, width, and height may be placed on the reference surface 102 to calibrate the measurement system 104.

The reference surface 102 may be a passive element upon which the object 10 rests. In some embodiments, the reference surface 102 may be a device for determining the weight or mass of object 10. For example, the reference surface 102 may be a scale for measuring weight.

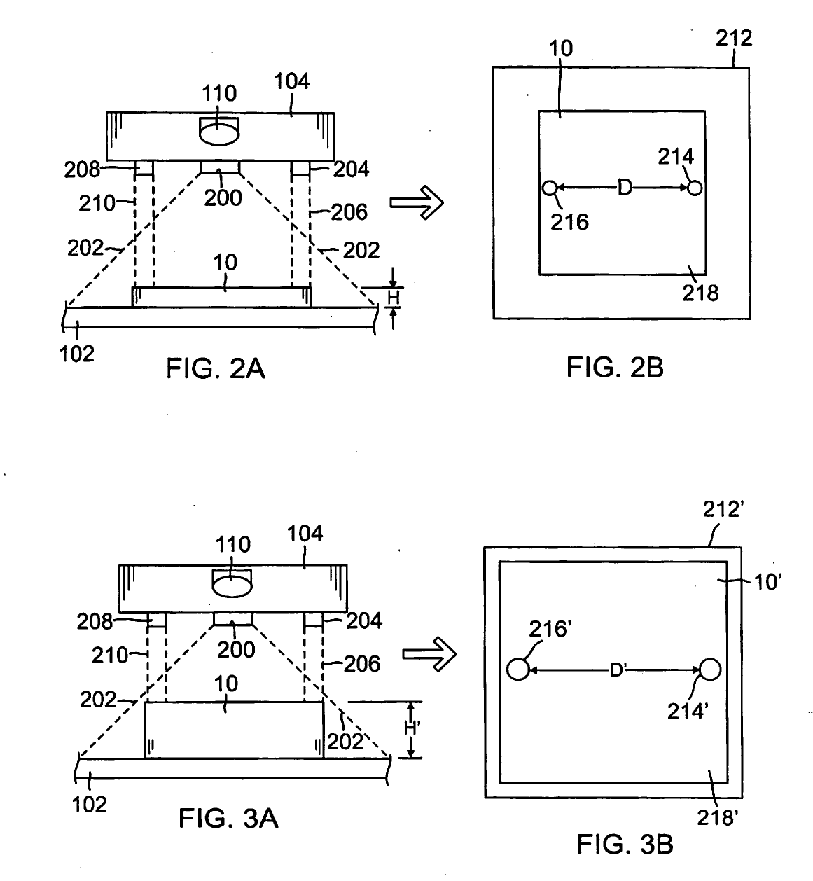

As shown in FIG. 2A the measurement system 104 comprises an optical detection device 200 above the reference surface 102 to capture a field of detection 202 and at least one laser 204 above the reference surface 102 generating a laser beam 206 directed towards the reference surface 102. The optical detection device 200 is a device, such as a digital camera, that can capture an image with measureable parameters, such as pixels. The field of detection 202 is determined by the lens type of the optical detection device 200 and the height of the optical detection device 200 above the reference surface 102 or the distance from an object 10 placed on top of the reference surface 102. Any image in the field of detection 202 may be captured by the optical detection device 200, stored, and processed by a processor 106, such as a computer, personal digital assistant, or other electronic device.

The laser beam 206 may be perpendicular to the reference surface 102 or it may be set at a predetermined angle. An object 10 may be placed on the reference surface 102 so that the laser beam 206 projects onto the object 10. In some embodiments, the measurement system 104 may have two lasers 204, 208 directed towards the reference surface 102. The two lasers 204, 208 may be arranged in any configuration relative to each other, projecting their respective laser beams 206, 210 towards the reference surface 102 or an object 10. In a preferred embodiment, the two lasers 204, 208 are positioned bilaterally to the optical detection device 200. In another embodiment, a plurality of lasers may direct a plurality of laser beams towards the reference surface 102. The laser beam 206 projected onto object 10 may be in the form of line segments, circles, squares, rectangles, triangles, or any other geometric configuration.

FIGS. 2A-3B illustrate how the optical detection device 200 and the lasers 204 and/or 208 are used in conjunction to determine or calculate certain characteristics, for example, the height, of an uncharacterized object or package 10′ placed on the reference surface 102. As shown in FIG. 2A, a reference object 10 of known dimensions is placed on top of the reference surface 102 and underneath the measurement system 104. In this embodiment, the optical detection device 200 is a digital camera having a known field of detection 202 that encompasses the entire reference object 10. Two lasers 204, 208 project their respective laser beams 206, 210 onto the reference object 10 within the field of detection 202. The camera 200 captures an image of the field of detection, referred to as a reference image frame 212. Thus, the reference image frame 212 comprises images of the laser beams, referred to as reference laser beam images 214, 216 and an image of the reference object, referred to as a reference object image 218. The reference distance D between the first reference laser beam image 214 and the second reference laser beam image 216 serves as a control. The processor 106 measures the reference distance D between the first reference laser beam image 214 and the second reference laser beam image 216. The reference distance D may be measured in traditional units of distance, such as inches or centimeters, or in terms of the number of pixels between the two reference laser beam images 214, 216.

As depicted in FIGS. 2A-5B, an object occupies less of a camera's field of detection 202 as the object gets further away from the optical detection device 200 (i.e. the height of the object 10 decreases). As such, the distance between the laser beam images will get smaller or there will be fewer pixels between the laser beam images as the object upon which the laser beam images are projected get farther from the camera. Conversely, an object occupies more of a camera's field of detection 202 as the object gets closer to the optical detection device 200 (i.e. the height of the object 10 increases). As such, the distance between the laser beam images will get larger or there will be more pixels between the laser beam images. Therefore, with the height of the optical detection device 200 fixed, a second object with unknown dimensions, referred to as an uncharacterized object 10′, may be placed on the reference surface 102 and a second image frame 212′ of the uncharacterized object 10′ captured thereby generating a second image frame 212′. The second image frame 212′ comprises the laser beam images now projected onto the uncharacterized object 10′, now referred to as variable laser beam images 214′, 216′ and an image of the uncharacterized object 10′, referred to as the variable object image 218′. The processor 106 can measure the variable distance D′ between the two variable laser beam images 214′, 216′.

If the height H of the reference object 10 is known, the height H′ of the uncharacterized object 10′ can be calculated based on the known height H of the reference object 10, the measurement of the reference distance D, and the measurement of the variable distance D′ because the ratio of the reference height H to the reference distance D should be the same as the ratio of the variable height H′ to the variable distance D′. In other words, H/D is proportional H′/D′. A conversion factor C can be determined based on how the change in height of a reference object correlates with the change in pixels in the object from a first height to a second height. Once the measurement system 104 is calibrated with a reference object of a known height, a new distance D′ can be measured using the measurement system 104 and the new height H′ can be calculated using the equation H′=(H/D)*D′*C, where H is a known height of the reference object 10, D is the measured distance between the reference laser beam images 214, 216 in the reference image frame 212, D′ is the measured distance between the variable laser beam images 214′, 216′ in the variable image frame 212′, and H′ is the height of the unknown object 10′.

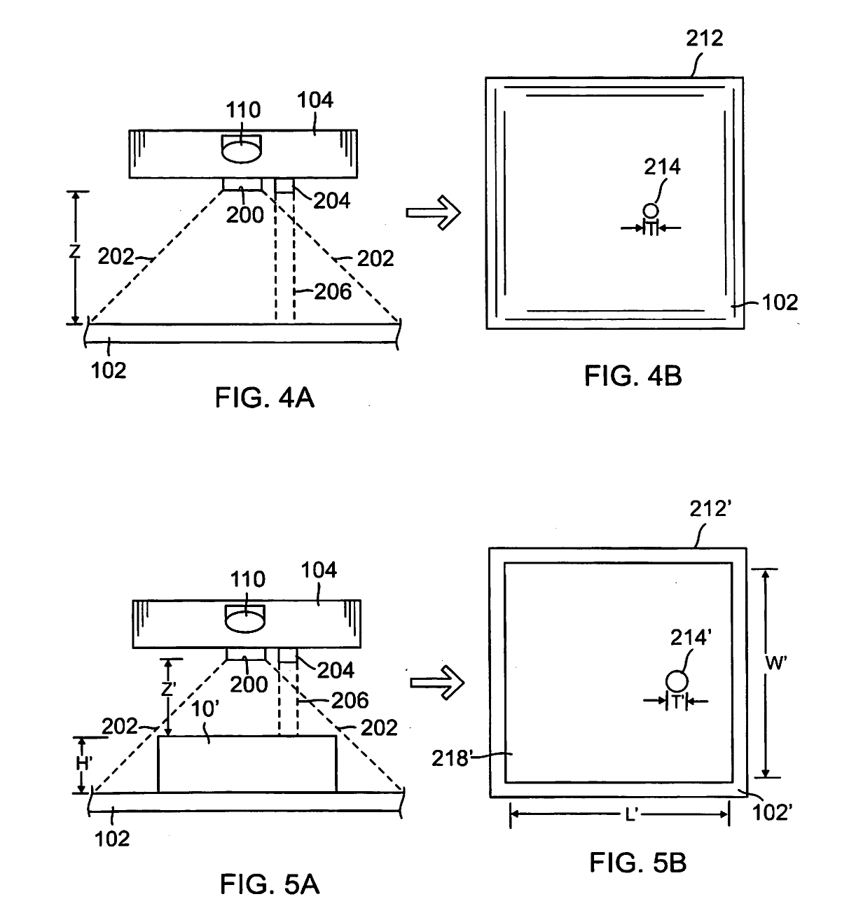

Again it will be appreciated that more or fewer lasers could be used. For example, in some embodiments as shown in FIGS. 4A-5B, a measurement system 104 comprising a camera 200 and a single laser 204 may be used. The measurement system 104 is positioned above the reference surface 102. The laser 204 may project a laser beam 206 having a fixed dimension T, for example, a fixed width if the laser beam projects a line, a fixed diameter if the laser beam projects a circle, a fixed length and width if the laser projects a square or rectangle, etc., onto the reference surface 102, which is at a predetermined distance Z from the camera 200. The camera 200 can capture the reference image frame 212 with the laser beam image 214. The processor 106 calculates the number of pixels within at least one dimension T of the laser beam image (e.g. length, width, diameter, etc.). The number of pixels can then be correlated with the distance from the camera, or reference camera distance Z, which is known. An uncharacterized object 10′ may then be placed on the reference surface 102 underneath the camera 200 and laser 204 such that the laser beam 206 projects onto the uncharacterized object 10′. The camera 200 can capture a second image frame 212′ containing the laser beam 206 projecting onto the uncharacterized object 10′, now referred to as the variable laser beam image 214′. Since the uncharacterized object 10′ has a height H′ and the laser beam 206 is projecting onto the uncharacterized object 10′ the distance between the camera 200 and the top of the uncharacterized object 10′, referred to as the variable camera distance Z′ will be smaller and the resultant variable laser beam image 214′ will be closer to the camera and, therefore, occupy more of the camera's field of detection 202 and, therefore, occupy more of the second image frame 212′. As such, the variable laser beam image 214′ will contain more pixels within its dimension T′. The processor 106 can measure the number of pixels in the variable laser beam image 214′, and calculate the variable camera distance Z′ based on the number of pixels in the reference laser beam image 214 from the reference image frame 212, the reference camera distance Z, and the conversion factor C. In this case, the variable camera distance Z′ is inversely proportional to the dimension X′. Thus, as the variable camera distance Z′ gets smaller, the dimension X′ gets larger. Since the reference camera distance Z is known, the actual height H′ of the uncharacterized object 10′ can be calculated as the difference between the reference camera distance Z and the variable camera distance Z′.

In some embodiments, the package dimensioner and reader may utilize a plurality of lasers. For example, if four lasers are used, the distance between each of two pairs of laser beam spots may be calculated. Advantageously, this pair of measurements provides for the possibility of error detection, thereby improving accuracy through averaging.

While the words laser, optical, and camera are used for convenience in explanation, it will be appreciated that aspects of the present invention may be implemented using similar devices that function in other ranges of the electromagnetic spectrum or by other means of transmission. For example, radiation sources operating outside of the visible spectrum coupled with a detector capable of detecting such radiation may also be used under certain conditions.

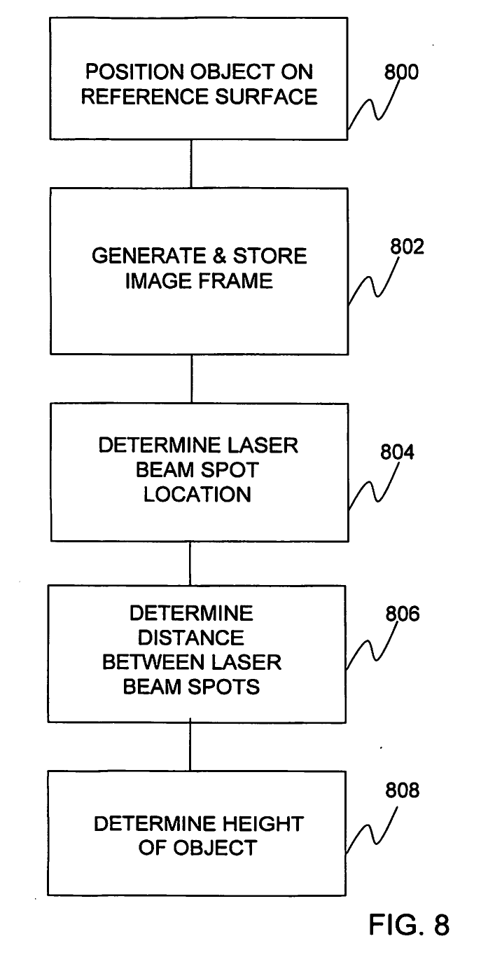

FIG. 8 illustrates a flow diagram for utilizing the system to measure the height H′ of an uncharacterized object 10′ according to one embodiment of the present invention as depicted in FIG. 2A-5B. The method begins by placing 800 an uncharacterized object 10′ on the reference surface 102. Preferably, the uncharacterized object 10′ is positioned directly under the measurement system 104 to ensure that all of the laser beams 206 and/or 210 intersect the upper surface of the uncharacterized object 10′. After the uncharacterized object 10′ is positioned on the reference surface, an image frame 212′ is generated 802. The optical detection device 200 of the measurement system 104 generates the image frame depicting the visible upper surface of the uncharacterized object 10′ and the laser beam images 204′, 216′. In order to determine the height H′ of the uncharacterized object 10′, the image frame 212′ then undergoes processing. One way to perform this processing is to first determine 804 the location of the laser beam images 214′, 216′ within the image frame 212′. In one embodiment, each laser beam image 214′, 216′ can be treated as being centered at a particular pixel within the image frame 212′. After determining the location of each laser beam image 214′, 216′ within the variable image frame 212′, the distance D′ between corresponding laser beam images 214′, 216′ is determined 806.

In some embodiments, the distance measurements are made in units of pixels. After determining the distance D′ between the laser beam images 214′, 216′, the actual height H′ of the uncharacterized object 10′ is calculated 808. In some embodiments, the correlation between various heights H′ and the distances D′ can be stored in a database and readily available as a look up table. A table of actual heights and pixel measurements can be generated before hand and the height H′ corresponding to the current distance D′ measurements can be quickly accessed. Thus, prior to characterizing any uncharacterized object 10′, a reference object 10, can be used to generate a conversion factor for the database. In one embodiment, the height dimension is determined to the accuracy of tenths of an inch. Advantageously, the present method, and the associated system provide a means for quickly and accurately determining the height H′ of an uncharacterized object 10′

In addition to determining the height H′ of an uncharacterized object 10′, the present system may also be used to determine additional characteristics of an uncharacterized object 10′ in accordance with an embodiment of the present invention. For example, the length L′ and width W′ of an uncharacterized object 10′ may be determined as well.

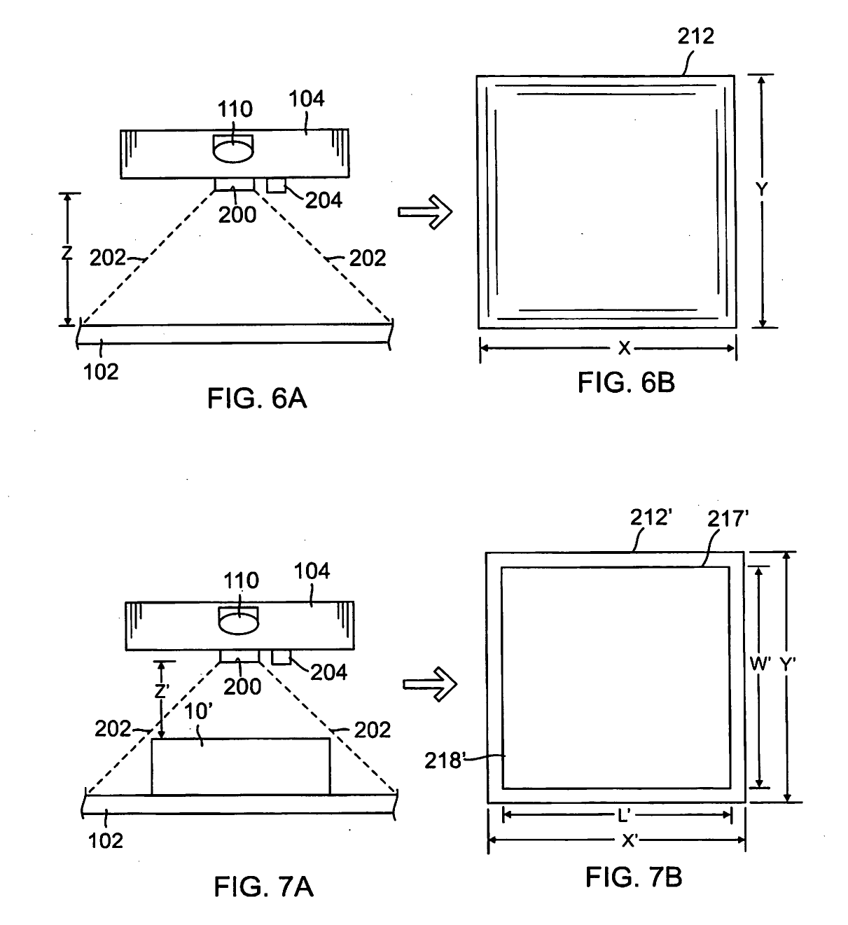

As shown in FIGS. 6A-7B, the measurement system may capture a reference image frame 212 of the reference surface 102 without any objects on it. Since the reference surface 102 is a known constant and the camera height Z is fixed, the number of pixels within the reference surface 102 can be correlated with the size or dimensions of the actual portion of the reference surface 102 captured. Therefore, as a control, only the blank features of the reference surface 102 are captured. When an uncharacterized object 10′ is placed on the reference surface 102 as shown in FIG. 7A, a contrasting boundary 217′ is created on the variable image frame 212′ outlining the shape of the variable object image 218′ as shown in FIG. 7B. By comparing the pixels in the reference image frame 212 and the variable image frame 212′, the variable object image 218′ can be determined since the pixels defining the variable object image 218′ have changed relative to the pixels defining the reference image frame 212. With the height H′ of the uncharacterized object previously determined, the differences between the reference image frame 212 and the variable image frame 212′ can be used to calculate the length L′ and width W′ of the uncharacterized object 10′ using simple algebraic, geometric and/or trigonometric principles.

For example, if the uncharacterized object 10′ is square or rectangular, the length L′ and width W′ of the object may be the additional desired characteristics. If the uncharacterized object 10′ is circular, the radius or circumference may be additional desired characteristics. For other shapes, the perimeter may be a desired characteristic. In one embodiment, the representative values of these desired characteristics are determined by comparing the reference image 212 frame with the variable image frame 212′ generated during execution of the steps described above. Differences between the reference image frame 212 and the variable image frame 212′ are analyzed to generate an outline of the uncharacterized object 10′.

In one embodiment, as depicted in FIGS. 6A-7B, the desired characteristics of the uncharacterized object 10′ are measured on this outline in numbers of pixels. For example, if the uncharacterized object 10′ is rectangular, the longer axis or length L of the outline can be determined by image analysis yielding a pixel-length value for the length L. Circumferences, perimeters, widths, and other characteristics can similarly be determined in terms of pixels. After the representative values of the desired characteristics are determined, the actual value of the desired characteristics is calculated using algebraic, geometric, and trigonometric, or other mathematical principles.

Using a reference object 10 with known dimensions, a conversion factor between pixel-length and a unit of distance (e.g. inches, centimeters, etc.) may be determined. Using the determined conversion factor, the representative pixel values may be converted into actual measurements. For example, if the uncharacterized object 10′ is square or rectangular and the length L′ and width W′ had been determined in terms of pixels, a conversion factor such as P pixels per inch or per centimeter could be determined based on how the pixel numbers change within an object based on the height of the object (or the variable camera height Z′). Dividing the pixel-lengths by the conversion factor would determine the actual length and width of the object. In one embodiment, as with the case for converting a pixel measurement into the height of the object, these conversion factors may be determined before hand for quick and easy access during processing. Other algebraic, trigonometric, geometric, and other mathematical principles and formulae may be applied to calculate the actual dimensions of an uncharacterized object 10′, such as length, width, height, diameter, perimeter, area, circumference, etc., from pixel counts.

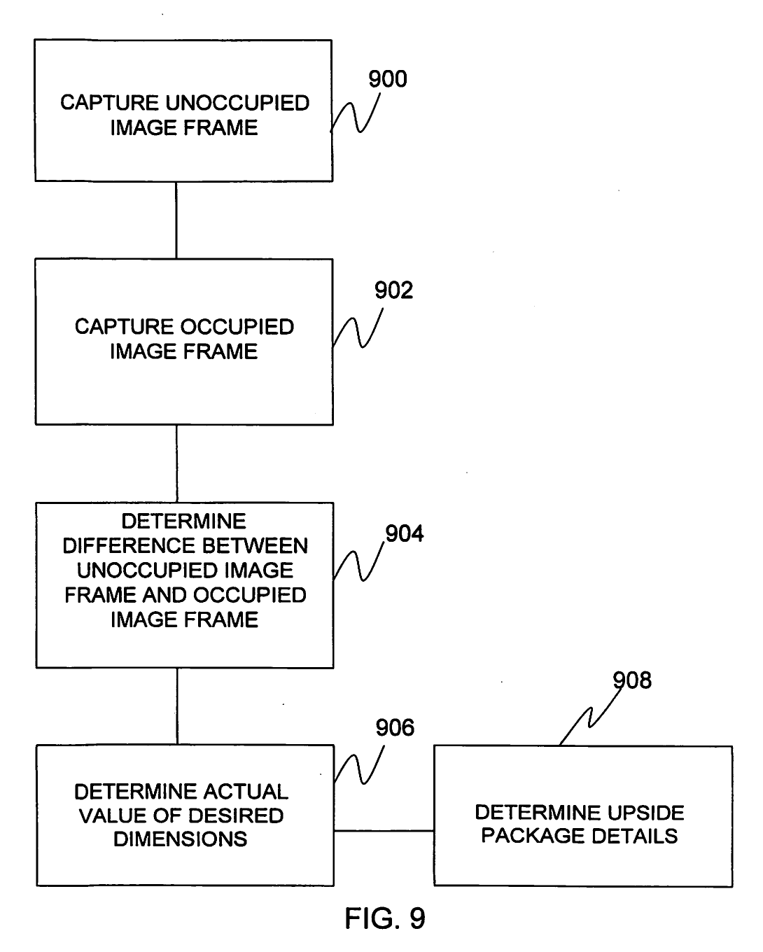

FIG. 9 depicts a flow diagram for determining other characteristics of an uncharacterized object 10′ according to an embodiment of the present invention as depicted in FIGS. 6A-7B. The method begins by capturing 900 an unoccupied, reference image frame 212. In one embodiment, this unoccupied, reference image frame 212 serves as base line for subsequent differential image analysis. After capturing the unoccupied, reference image frame 212, a variable image frame 212′ containing an uncharacterized object 10′ is captured 902. The reference image frame 212 and the variable image frame 212′ are compared 904 to determine the differences in pixel characteristics between the reference image frame 212 and the variable image frame 212′ as defined by a contrasting boundary 217′. The processor can determine the general shape 906 of the contrasting boundary 217′. If the contrasting boundary 217′ is determined to be a square or rectangle, then the processor can proceed to calculate the length L′ and width W′ of the contrasting boundary. With the actual height H previously determined, the actual length L and width W of the object can be determined. If the contrasting boundary 217′ is determined to be a circle, the perimeter and radius may be determined. If the processor is unable to determine the shape or characteristic of the object 10 then a manual override button can be pressed so that the characteristics can be manually inputted. Upside packaging details can also be determined 908 using an optical character recognition software to analyze text captured by the optical detection device 200.

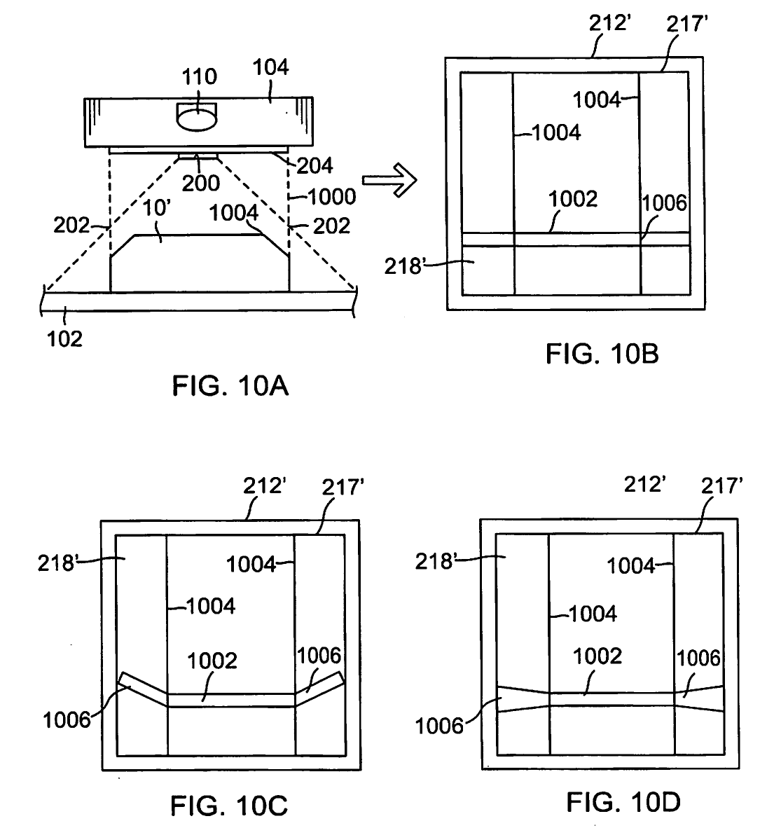

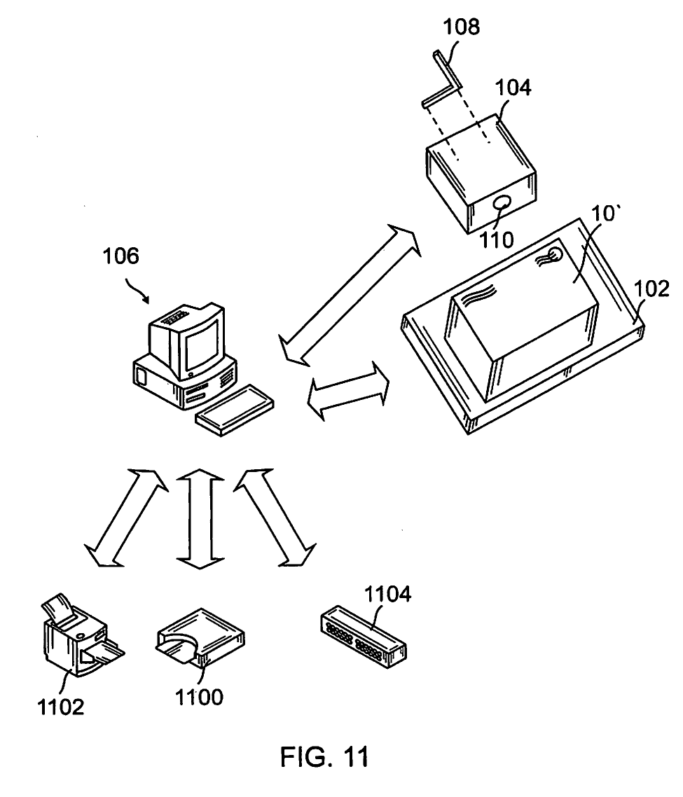

As shown in FIG. 10A-10D, in some embodiments, the package dimensioner and reader may utilize a light source 204, for example a laser or other light source that emits a line segment (similar to lights emitted by barcode readers) to determine whether an uncharacterized object is rectangular (i.e. cubic or box-shaped). The shape of the uncharacterized object 10′ is an important mailing criterion. Boxes, letters and large envelopes with square corners are considered rectangular. Tubes, triangles, globes, cylinders and pyramids are shapes that are not considered rectangular. Many nonrectangular items appear rectangular when evaluated as a 2-dimensional image. However an analysis of the captured laser image can reveal whether the object is truly rectangular, cubic or otherwise, box-shaped.

For example, a laser line beam 1000 may be projected across the field of detection 202 either orthogonal or oblique to reference surface 102. An uncharacterized object 10′ having a non-uniform top surface (e.g. cylindrical container on its side, pyramidal container, trapezoidal container, etc.) may be placed under the laser line beam 1000 such that the non-uniform portion or the point of change 1004 intersects the laser line beam 1000. The laser line beam 1000 generating a laser line segment 1002 on top of the uncharacterized object 10′ would create a laser line segment 1002 with uniform characteristics where the top surface is uniformly flat. If, however, the distance of the top surface to the laser source 204 changes (e.g. the top surface is not uniformly flat due to curve, slope, dip, etc.), then a change in the characteristic of the laser line segment 1002 would be present. For example, the portion of the laser line beam 1000 projecting on to the point of change 1004 of the surface of the uncharacterized object 10′ may cause a diffraction, deflection, or an otherwise altered absorption of the laser line beam 1000. This change would indicate that the top surface is not uniform and translate into an alteration 1006 of the laser line segment 1002. If the laser line beam 1000 is orthogonal to the reference surface 102, then the alteration 1006 in the laser line segment may be a change in contrast as shown in FIG. 10B. For example, the alteration 1006 may be a darkened segment or a brighter segment depending on the material of the uncharacterized object 10′.

In some embodiments, the laser line segment may project onto the uncharacterized object 10′ at an oblique angle or an angle not orthogonal to the top surface. Again, where the top surface is uniform, the projected laser line segment 1002 is also uniform in shape. At the location where the top surface changes, the laser line segment 1002 projected onto the surface at the point of change 1004 experiences an alteration 1006 in characteristic. For example, the laser line segment 1002 may appear bent at the point of change 1004 on the top surface as shown in FIG. 10C.

In some embodiments, the laser line beam 1000 may be projected incident to the reference surface 102 and the optical detection device 200 may be pointed at an oblique angle to the reference surface 102 so that a perspective view of the uncharacterized object 10′ is seen. In such an embodiment, the location where the change 1004 in the top surface of the uncharacterized object 10′ occurs, results in a break, bend or some other alteration 1006 in the laser line segment 1002 on the uncharacterized object 10′ depending on whether the change on the top surface is abrupt or gradual and the extent of the change 1004.

In some embodiments, using other types of light sources, a change in the distance of the top surface from the light source 204 results in a change in the dimension of the line segment formed on the top surface. For example, as shown in FIG. 10D as the distance from the top surface to the light source increases, the width of the line segment may also increase due to the diffraction of the light as it exits the light source 204. Conversely, a decrease in the width of the line segment on the top surface correlates with the distance between the top surface of the uncharacterized object 10′ and the light source 204 getting shorter.

Using control objects 10, the degree of the alteration 1006 in the line segment 1002 (e.g. the degree of change in contrast, the degree of change in the bend, the degree of change in the width of the line segment, etc.) may be used to calculate the extent of the change in the top surface.

Many different variations of placement of the light source 204 and the optical detection device 200 relative to the uncharacterized object 10′ or the reference surface 102 have been contemplated. In each case, an alteration 1006 in the laser line segment 1002 projected on the uncharacterized object 10′ at the point of change 1004 can be detected. Once the controls have been established, the changes in the line segment characteristics may be quantified to determine the precise shape of the uncharacterized object. In addition, a plurality of light sources may be used to more fully characterize the object using these principles.

In some embodiments, optional upside package details such as sender and recipient addresses, barcode package information, payment transaction number, additional services requested, and customs information can be examined 908. The processor may further comprise optical character recognition (OCR) and/or Zooming-In capabilities to examine the captured images for additional processing. Thus, any text or barcode information on the top surface of an uncharacterized object may be captured by the optical detection device 200 and read by the processor to determine additional information.

This additional information may include a picture of the customer, a picture of the package, an OCR reading of the package sender and receiver information, a payment transaction number, barcode information containing packaging information, additional services requested, and customs information.

In some embodiments, the optical detection device 200 may be movable to alter the field of detection 202. For example, the optical detection device 200 may be directed towards the uncharacterized object 10′, then moved to an oblique position relative to the lasers to take a picture of the customer.

In some embodiments, the package dimensioner and reader may comprise a second optical detection device 110 to capture an image of the customer or any other intended image.

The package dimensioner and reader 100 may also include a support member 108. As illustrated in FIG. 1, the support member 108 may be attached to both the reference surface 102 and the measurement system 104. The support member 108 serves to suspend the measurement system 104 above the object 10. The support member 108 may also be used to conceal wiring associated with the measurement system 104 and reference surface 102. In some embodiments, the support member 108 may hang the measurement system 104 from the ceiling.

The package dimensioner and reader may be integrated into a single mailing point of sale system. The processor 106 communicates with the measurement system 142, a scale for measuring weight, a credit/debit card 1100, printer 1102, and barcode reader 1104. It will be appreciated that the processor may be internal to either the measurement system 104 or the scale, or may be housed separately. For example, the processor 106 associated with memory executes code to orchestrate the interaction of the systems. In another example, the processor 106 may be a personal computer (PC) or other general-purpose computer or application specific integrated circuit (ASIC) or other programmable logic designed to carry out the described functionality.

In use, a reference image frame 212 is generated. The reference surface 102 comprising a scale alerts the processor 106 that the scale has reached a steady state, non-zero weight after an uncharacterized object 10′ was placed on the reference surface 102. The processor 106 alerts the measurement system 104 to activate the lasers 204, 208. The processor 106 alerts the measurement system 104 to activate the cameras 200, 800. The measurement system 104 generates variable image frames 212′ and sends it to the processor 106. The processor 106 determines the height H′ of the uncharacterized object 10′ by converting the variable distance D′ between laser beam images 214′, 216′ into height H′ based on a predetermined conversion factor. The processor 106 determines an outline of the uncharacterized object 10′ by comparing the reference image frame 212 to the variable image frame 212. The processor 106 determines the length L′ and width W′, or other pertinent characteristics, in numbers of pixels. The processor 106 determines the actual length L′ and width W′, or other pertinent characteristics, by converting from pixels to actual length based on the conversion factor. The processor 106 determines and processes optional upside package details and customer picture.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A package dimensioner and reader, comprising:
a. a reference surface to support an object;
b. a measurement system, comprising:
i. a plurality of lasers above the reference surface generating a plurality of first laser beams directed towards the reference surface, and
ii. a first optical detection device, above the reference surface and adjacent to the plurality of lasers, wherein the first optical detection device is directed towards the reference surface to capture an image frame; and
c. a processor operatively connected to the measurement system to process the image view captured by the optical detection device.

2. The package dimensioner and reader of claim 1, wherein the image frame comprises a plurality of laser beam images within the image frame.

3. The package dimensioner and reader of claim 2, wherein the processor determines at least one variable distance between a first laser beam image and a second laser beam image to calculate a characteristic of the object.

4. The package dimensioner and reader of claim 3, wherein the characteristic of the object is the height of the object.

5. The package dimensioner and reader of claim 3, wherein the processor determines a plurality of variable distances between pairs of laser beam images.

6. The package dimensioner and reader of claim 1, further comprising a second optical detection device oblique to the first optical detection device to capture a non-object related information.

7. The package dimensioner and reader of claim 1, wherein the processor comprises an optical character recognition software to read information on the object.

8. The package dimensioner and reader of claim 1, further comprising a support member to support the measurement system above the reference surface.

9. The package dimensioner and reader of claim 1, wherein the reference surface further comprises a scale to measure a weight of the object.

10. The package dimensioner and reader of claim 1, further comprising a means for determining a shape of the object.

11. A package dimensioner and reader, comprising:
a. a reference surface to support an object;
b. a measurement system, comprising:
i. a laser above the reference surface generating a laser beam directed towards the reference surface, and
ii. a first optical detection device, above the reference surface and adjacent to the laser, wherein the first optical detection device is directed towards the reference surface to capture an image frame; and
c. a processor operatively connected to the measurement system to process the image frame captured by the first optical detection device.

12. The package dimensioner and reader of claim 11, wherein the image frame comprises a laser beam image within the image frame, wherein the laser beam image has a dimension.

13. The package dimensioner and reader of claim 12, wherein the processor calculates a variable distance of the dimension of the laser beam image, wherein the variable distance can be converted to an actual characteristic of the object based on a predetermined conversion factor.

14. The package dimensioner and reader of claim 13, wherein the laser beam is orthogonal to the reference surface.

15. The package dimensioner and reader of claim 11, further comprising a second optical detection device oblique to the first optical detection device to capture a non-object related information.

16. The package dimensioner and reader of claim 11, wherein the processor comprises an optical character recognition software to read information on the object.

17. The package dimensioner and reader of claim 11, further comprising a support member to support the measurement system above the reference surface.

18. The package dimensioner and reader of claim 11, further comprising a means for determining a shape of the object.

19. The package dimensioner and reader of claim 18, wherein the laser beam forms a line segment.

20. The package dimensioner and reader of claim 19, wherein the line segment comprises an alteration correlating to a change in a surface feature of the object.

21. A method of automatically determining a characteristic of an object at a point of object acceptance, comprising:
a. projecting a laser beam onto the object placed on a reference surface;
b. capturing an image of the object and an image of the laser beam on the object with an optical detection device fixed at a predetermined distance from the reference surface to generate a variable image frame comprising a laser beam image having a dimension and an object image;
c. measuring the dimension of the laser beam image; and
d. characterizing the object based on the dimension of the laser beam image, thereby determining the characteristic of the object at the point of package acceptance.

22. The method of claim 21, further comprising:
a. projecting the laser beam onto the reference surface, wherein the laser beam is a predetermined height from the reference surface;
b. capturing a reference image frame of the reference surface and an image of the laser beam on the reference surface with the optical detection device fixed at a predetermined reference distance from the reference surface to generate a reference image frame having a known dimension comprising a reference laser beam image having a reference dimension;
c. calculating a conversion factor based on a mathematical relationship between the reference distance and the reference dimension; and
d. calculating the characteristic of the object based on the conversion factor and the dimension of the laser beam image.

23. The method of claim 22, further comprising the step of creating a database comprising a plurality of characteristics, wherein each characteristic correlates with a specific dimension of the laser beam image.

24. The method of claim 22, further comprising determining additional features of the object by:
a. measuring a reference image frame length and a reference image frame width;
b. measuring a variable image frame length and a variable image frame width;
c. comparing the reference image frame with the variable image frame to determine a differential image frame;
d. measuring a differential image frame length and a differential image frame width;
e. determining a length proportional relationship between the differential image frame length and the variable image frame length;
f. determining a width proportional relationship between the differential image frame width and the variable image frame width; and
g. determining the length and the width of the object based on the length and width proportional relationships and the conversion factor.

25. The method of claim 21, further comprising determining additional features of the object by:
a. determining an alteration in the laser beam image; and
b. correlating the alteration in the laser beam image with a change of a surface characteristic of the object.

26. A method of automatically determining a characteristic of an object at a point of object acceptance, comprising:
a. projecting a first laser beam and a second laser beam onto the object placed on a reference surface;
b. capturing an image of the object and an image of the first and second laser beams on the object with an optical detection device fixed at a predetermined distance from the reference surface to generate an image frame comprising a first laser beam image, a second laser beam image, and an object image;
c. measuring a variable distance between the first laser beam image and the second laser beam image; and
d. determining the characteristic of the object based on the variable distance.

27. The method of claim 26, further comprising:
a. projecting the first and second laser beams onto the reference surface, wherein the first and second laser beams are a predetermined height from the reference surface;
b. capturing a reference image of the reference surface and an image of the laser beam on the reference surface with the optical detection device fixed at a predetermined reference distance from the reference surface to generate a reference image frame having a known dimension comprising a reference laser beam image having a reference dimension;
c. calculating a conversion factor based on a mathematical relationship between the reference distance and the reference dimension; and
d. calculating the characteristic of the object based on the conversion factor and the dimension of the laser beam image.

28. The method of claim 27, further comprising the step of creating a database comprising a plurality of characteristics, wherein each characteristic correlates with a specific dimension of the laser beam image.

29. The method of claim 27, further comprising determining a length and a width of the object by:
a. measuring a reference image frame length and a reference image frame width;
b. measuring a variable image frame length and a variable image frame width;
c. comparing the reference image frame with the variable image frame to determine a differential image frame;
d. measuring a differential image frame length and a differential image frame width;
e. determining a length proportional relationship between the differential image frame length and the variable image frame length;
f. determining a width proportional relationship between the differential image frame width and the variable image frame width; and
g. determining the length and the width of the object based on the length and width proportional relationships and the conversion factor.
